(19) United States
(12) Patent Application Publication
(10) Pub. No.: US 2026/0300791 A1
(43) Pub. Date: Oct. 1, 2026

(54) Large-scale multi-qubit trapped-ion gates

(71) Applicants: YEDA RESEARCH AND DEVELOPMENT CO. LTD., Rehovot (IL); Quantum Art Ltd., Nes Ziona (IL)

(72) Inventors: Yotam Shapira, Rehovot (IL); Lee Peleg, Rehovot (IL); David Schwerdt, Rehovot (IL); Jonathan Nemirovsky, Rehovot (IL); Nitzan Akerman, Rehovot (IL); Adiel Stern, Rehovot (IL); Amit Ben Kish, Givat Ela (IL); Roee Ozeri, Rehovot (IL)

(21) Appl. No.: 19/489,905

(22) PCT Filed: May 23, 2024
(86) PCT No.: PCT/IB2024/055007

§ 371 Date: Dec. 4, 2025

Related U.S. Application Data
(60) Provisional application No. 63/506,142, filed on Jun. 5, 2023.

(51) Int. Cl. G06N 10/40; G06N 10/20; G06N 10/70

(52) U.S. Cl. CPC G06N 10/40; G06N 10/20; G06N 10/70

(57) ABSTRACT

A system (20) for quantum computing includes an array of qubits (40) and a radiation source (28), which applies simultaneously to multiple qubits in the array radiation including a set of spectral components in multiple vibrational sidebands of an internal transition frequency of the qubits with different, respective complex amplitudes. The sidebands are generated by a group of the normal modes having a minimal spacing Δf between the respective vibrational frequencies. A controller (32) initializes a multi-qubit gate, including at least five of the qubits, to an initial state and drives the radiation source to apply the radiation to each of the qubits with respective complex amplitudes of the spectral components in the set selected so as to switch the multi-qubit gate to a target state within a gate time that is less than 50/Δf.

### CROSS-REFERENCE TO RELATED APPLICATION

This application claims the benefit of U.S. Provisional Patent Application 63/506,142, filed Jun. 5, 2023, which is incorporated herein by reference.

### FIELD

The present invention relates generally to quantum computing, and particularly to large-scale trapped-ion gates in a quantum computer.

### BACKGROUND

Quantum computers apply principles of quantum physics in solving computational problems and have the potential to perform certain computations far more efficiently than existing digital computers. The basic building block of a quantum computer is the qubit. Quantum computers comprise of qubits and the gates that operate the qubits, including single-qubit, two-qubit, and multi-qubit gates.

Trapped-ion systems, in which individual atomic ions serve as qubits, hold promise as a scalable, reliable platform for quantum computing. In a trapped-ion system, the individual atomic ions are trapped by electric fields in an ultra-high vacuum and are cooled to their motional ground states. The internal electronic levels of the ions, as well as the motion of the ions in the trap, are controlled with high precision using lasers, microwaves, or radio-frequency (RF) fields. To perform computations, gates are applied to the internal and motional states of the atomic ions by driving fields with the appropriate spectra, i.e. frequencies, amplitudes, phases, and duration.

The prevalent approach to quantum computing is to break down algorithms into a concatenation of single-qubit and two-qubit gates. Multi-qubit gates made up of three or more qubits, however, have also been proposed. For example, Shapira et al. describes gates of this sort in an article entitled “Theory of robust multiqubit nonadiabatic gates for trapped ions,” published in Physical Review A 101, 032330 (2020), which is incorporated herein by reference.

Multi-qubit gates will be important in practical realizations of quantum error correction (QEC), to overcome the problem of physical qubit errors in a quantum computer. In QEC codes, quantum information is not stored directly in the individual physical qubits (for example, in individual trapped ions), but rather in logical qubits, which are composed of multiple physical qubits. A QEC scheme of this sort is described, for example, by Schwerdt et al., in “Comparing two-qubit and multiqubit gates within the toric code,” published in Physical Review A 105, 022612 (2022). In this article gates comprising five physical qubits are used to encode two logical qubits on the entire qubit register, with substantially increased threshold for fault tolerance as compared with stabilizer measurements, which is executed with a series of two-qubit physical gate.

Other applications of multi-qubit gates include substantially reducing the depth of quantum circuits by performing register-wide operations. For example, in “Synthesis of and compilation with time-optimal multi-qubit gates,” published in Quantum 7, 984 (2023), Bassler et al. use multi-qubit gates to generate N-qubit quantum Fourier transforms with 2N entangling gates. As another example, Bravyi et al. describe quantum circuits composed of single-qubit operations and global entangling gates generated by Ising-type Hamiltonians in “Constant-Cost Implementations of Clifford Operations and Multiply-Controlled Gates Using Global Interactions,” published in Physical Review Letters 129, 230501 (2022). Further uses of multi-qubit gates include quantum analog and digital simulations and quantum-classical hybrid optimization, as well as implementation of computational components comprising three or more logical gates.

### SUMMARY

Embodiments of the present invention that are described hereinbelow provide improved multi-qubit gates and methods for driving such gates.

There is therefore provided, in accordance with an embodiment of the invention, a system for quantum computing, including an array of qubits having an internal transition frequency from a ground state to an excited state and having multiple normal modes of vibrational motion among the qubits in the array, the normal modes having respective vibrational frequencies. A radiation source is configured to apply simultaneously to multiple qubits in the array radiation including a set of spectral components in multiple vibrational sidebands of the internal transition frequency such that the spectral components are applied to each of the qubits with different, respective complex amplitudes. The sidebands are generated by a group of the normal modes having a minimal spacing Δf between the respective vibrational frequencies of the normal modes in the group. A controller is configured to initialize a multi-qubit gate, including at least five of the qubits in the array, to an initial state and to drive the radiation source to apply the radiation to each of the qubits with respective complex amplitudes of the spectral components in the set selected so as to switch the multi-qubit gate to a target state within a gate time that is less than 50/Δf.

In a disclosed embodiment, the respective vibrational frequencies of the normal modes in the group extend over a frequency range from a minimum normal-mode frequency to a maximum normal-mode frequency, and the controller is configured to drive the radiation source to apply the radiation with a bandwidth that is at least 10% of the frequency range.

In some embodiments, the system includes an ion trap, wherein the array of qubits includes an array of ions held in the trap, and wherein the multi-qubit gate includes at least five of the ions in the array. In one embodiment, the internal transition frequency is an electronic transition frequency, and applying the radiation includes applying laser radiation. In another embodiment, the internal transition can be Hyperfine or Zeeman frequency, driven by an optical source in a Raman transition configuration. In yet another embodiment, applying the radiation includes applying radio-frequency (RF) radiation. In a disclosed embodiment, the array of the ions is a linear array.

In a disclosed embodiment, the multi-qubit gate includes more than twelve of the qubits in the array. Additionally or alternatively, the gate time is less than 10/Δf.

In some embodiments, the multi-qubit gate is configured to implement a quantum error correction code, such as a surface code.

In a disclosed embodiment, the target state of the multi-qubit gate is characterized by a target entanglement phase vector q, and the respective complex amplitudes of the spectral components are chosen by finding an initial set of the complex amplitudes that will yield zero entanglement phase, followed by optimization of the complex amplitudes to produce the target entanglement phase vector.

In some embodiments, the target state is a highly connected entangled state. Additionally or alternatively, the target state includes multiple non-local entanglements.

There is also provided, in accordance with an embodiment of the invention, a method for quantum computing, which includes providing an array of qubits having an internal transition frequency from a ground state to an excited state and having multiple normal modes of vibrational motion among the qubits in the array, the normal modes having respective vibrational frequencies. A multi-qubit gate, including at least five of the qubits in the array, is initialized to an initial state. Radiation is applied simultaneously to multiple qubits in the array. The radiation includes a set of spectral components in multiple vibrational sidebands of the internal transition frequency such that the spectral components are applied to each of the qubits with different, respective complex amplitudes. The sidebands are generated by a group of the normal modes having a minimal spacing Δf between the respective vibrational frequencies of the normal modes in the group. The respective complex amplitudes of the spectral components in the set are selected so as to switch the multi-qubit gate to a target state within a gate time that is less than 50/Δf.

There is additionally provided, in accordance with an embodiment of the invention, a method for quantum computing, which includes providing an array of qubits having an internal instantaneous transition frequency ω₀ from a ground state to an excited state. A multi-qubit gate, including a first number N>2 of the qubits in the array, is initialized to an initial state. A second number M>2 of excitation frequency pairs is selected, having respective frequencies ω_{0±}ωₘ and respective amplitudes rₘ defined by an amplitude vector R=<r₁, r₂, . . . , r_{M}>. A set of N(N−1)/2 coupling matrices A_{n,m} is defined with 1<n<m<N and having dimensions M×M representing interactions between the excitation frequency pairs and qubits pairs. An initial amplitude vector r₀ is found satisfying the constraint |r₀|=1 such that

$${r}_{0}^{T} {A}_{j} {r}_{0} = 0$$

for all j=1, . . . , N. A target entanglement phase vector φ=<φ_{1,2}, φ_{1,3}, . . . φ_{1,N}, φ_{2,1} . . . , φ_{N-1,N}> is selected. Parameters λ and D are computed to find a target amplitude vector R=λR₀+D that satisfies R^{T} Ä_{n,n}R=φ_{n,n} for all 1<n<m<N,

$${R}^{T} = ( {r}_{1}^{T} , {r}_{2}^{T} , … , {r}_{N}^{T} ) ,$$

wherein

$${R}_{0} = ( {r}_{0}^{T} , {r}_{0}^{T} , … , {r}_{0}^{T} ) .$$

The multi-qubit gate is driven to a target state by applying radiation to the array of qubits, the radiation including the M excitation frequency pairs with amplitudes in accordance with the target amplitude vector R.

In some embodiments, the vectors

$${r}_{1}^{T} , … , {r}_{N}^{T}$$

are found satisfy additional linear constraints,

$${Lr}_{n}^{T} = 0 ,$$

which are used to ensure disentanglement between qubit states and motional modes, as well as resilience to various sources of error and noise. In these cases, the vectors

$${r}_{n}^{T} and {r}_{0}^{T}$$

are found within the null space (kernel) of L.

In some embodiments, the method includes, after finding the target amplitude vector R, applying a process of optimization to find an optimized target vector Rₒₚₜ locally satisfying the constraint argmin |Rₒₚₜ| such that Rₒₚₜ^{T} Ã_{n,m} Rₒₚₜ=φ_{n,m} for all 1<n<m<N. Typically, applying the process of optimization includes reducing a residual error in a target phase φ_{n,m}. Additionally or alternatively, applying the process of optimization includes iteratively modifying the target amplitude vector so as to reduce a magnitude of the target amplitude vector while reaching the target entanglement phase vector to within a predefined error.

In some embodiments, the respective frequencies ω_{0±}ωₘ are chosen to excite sidebands of the transition frequency due to a group of normal modes of vibration of the qubits. In a disclosed embodiment, the respective vibrational frequencies of the normal modes in the group extend over a frequency range from a minimum normal-mode frequency to a maximum normal-mode frequency, and the chosen frequencies extend over a bandwidth that is at least 10% of the frequency range. Additionally or alternatively, the sidebands are generated by a group of the normal modes having a minimal spacing Δf between the respective vibrational frequencies of the normal modes in the group, and wherein the target amplitude vector is computed so that the multi-qubit gate switches to the target state within a gate time that is less than 50/Δf.

In a disclosed embodiment, finding the target amplitude vector includes computing, for each of the qubits, different, respective complex amplitudes of the excitation frequency pairs.

Additionally or alternatively, the method includes defining a gate time T of the multi-qubit gate, wherein computing the target amplitude vector includes selecting the target amplitude vector so as that the multi-qubit gate switches to the target state at the defined gate time.

Further additionally or alternatively, the method includes defining a target infidelity of the multi-qubit gate, wherein computing the target amplitude vector includes selecting the target amplitude vector so as that the multi-qubit gate switches to the target state with an infidelity no greater than the target infidelity.

In a disclosed embodiment, the qubits include trapped ions, the internal transition frequency is an electronic transition frequency, and applying the radiation includes applying laser radiation.

In some embodiments, the multi-qubit gate includes at least five qubits or even more than twelve qubits.

In a disclosed embodiment, the multi-qubit gate is configured to implement a quantum error correction code.

Typically, finding the initial amplitude vector includes solving a set of quadratic constraints of an order N.

In some embodiments, the multi-qubit gate gives rise to a highly connected entangled state and/or to multiple non-local entanglements.

There is further provided, in accordance with an embodiment of the invention, a system for quantum computing, including an array of qubits having an internal instantaneous transition frequency ω₀ from a ground state to an excited state, and a radiation source, configured to initialize a multi-qubit gate, including a first number N>2 of the qubits in the array, to an initial state, and to drive the multi-qubit gate to a target state by applying radiation to the array of qubits. The radiation includes a second number M>2 of excitation frequency pairs having respective frequencies ω₀±ωₘ and respective amplitudes rₘ defined by a target amplitude vector R=<r₁, r₂, . . . , r_{M}>. The target amplitude vector R is computed by defining a set of N(N−1)/2coupling matrices A_{n,m} with 1<n<m<N having dimensions M×M representing interactions between the excitation frequency pairs and qubits pairs, finding an initial amplitude vector r₀ satisfying the constraint |r₀|=1 such that

$${r}_{0}^{T} {A}_{j} {r}_{0} = 0$$

for all J=1, . . . , N, selecting a target entanglement phase vector φ=<Ω_{1,2}, φ_{1,3}, . . . φ_{1,N}, φ_{2,1} . . . , φ_{N-1,N}>, and computing parameters λ and D to find the target amplitude vector R=λR₀+D that satisfies R^{T} Ã_{n,n}R=φ_{n,n} for al 1<n<m<N, with

$${R}^{T} = ( {r}_{1}^{T} , {r}_{2}^{T} , … , {r}_{N}^{T} ) ,$$

wherein

$${R}_{0} = ( {r}_{0}^{T} , {r}_{0}^{T} , … , {r}_{0}^{T} ) .$$

The present invention will be more fully understood from the following detailed description of the embodiments thereof, taken together with the drawings in which:

### BRIEF DESCRIPTION OF THE DRAWINGS

FIG. 1 is a block diagram that schematically illustrates a quantum computing system, in accordance with an embodiment of the invention;

FIG. 2 is a block diagram that schematically illustrates an array of trapped ions configured as qubits in a quantum computer, in accordance with an embodiment of the invention;

FIG. 3 is a flow chart that schematically illustrates a method for selecting parameters to drive a multi-qubit gate, in accordance with an embodiment of the invention;

FIG. 4 is a plot that schematically illustrates a simplified example of the selection of amplitudes of spectral components used in driving a multi-qubit gate using the method of FIG. 3, in accordance with an embodiment of the invention;

FIGS. 5A and 5B are diagrams showing physical and logical arrangements, respectively, of an array of trapped ions implementing a surface code for use in quantum error correction, in accordance with an embodiment of the invention;

FIG. 6 is a plot that schematically illustrates the drive amplitudes of the ions in the physical array of FIG. 5A, in accordance with an embodiment of the invention;

FIG. 7 is a plot that schematically illustrates the amplitudes of spectral components of radiation used to drive the physical array of FIG. 5A, in accordance with an embodiment of the invention; and

FIG. 8 is a plot that schematically illustrates the amplitude of vibrational motion over time of the ions in the physical array of FIG. 5A, in accordance with an embodiment of the invention.

### DETAILED DESCRIPTION

### Overview

In trapped-ion systems, entanglement gates are typically generated by driving the ions with electromagnetic fields that create phonon-mediated qubit-qubit interactions. This sort of drive scheme uses vibrational sidebands of an internal transition frequency of the ions. In small multi-qubit gates, the trapped ions have only a few normal modes of vibration, and it is therefore relatively easy to choose a set of excitation frequencies and amplitudes that will lead to the desired target entanglement phase and gate time (i.e., the time required to drive the gate from its initial state to the target entangled state).

As the number of qubits increases, however, the number and complexity of the normal modes of vibration grows rapidly. Choosing a set of sideband frequencies and amplitudes to drive transitions of a multi-qubit gate robustly (i.e., with high fidelity) and quickly (with low gate time) is a quadratically constrained hard optimization problem. Finding an optimal set of drive frequencies and amplitudes is difficult even for gates containing as few as four qubits.

Some embodiments of the present invention that are described herein address this difficulty by providing a systematic method for selecting drive frequencies and amplitudes for a gate comprising an array of N qubits, with N>2. In these embodiments, the hard optimization problem, with constraints on the order of N², is reduced to a special instance with polynomial complexity, with quadratic constraints only on the order of N to be solved to find a solution for a certain instance of a bi-partite multi-qubit gate (i.e., a gate in which the entanglement phases are defined for each pair of qubits, and the qubits are driven in parallel to the target entanglement phases). This special solution can then be converted, using linear transformations and local optimization, to an optimized, generalized solution. Thus, an optimized set of drive frequencies and amplitudes, which will enable driving the multi-qubit gate to carry out desired bi-partite entanglement operations with a short gate time, can be derived quickly, including gates with more than twelve qubits.

To implement this sort of solution, in some embodiments of the invention, a number M>2 of excitation frequency pairs is selected, with respective frequencies ω_{0±}ωₘ and respective amplitudes rₘ defined by an amplitude vector r=<r₁, r₂, . . . , r_{M}> that is to be applied to each of the qubits. (Here ω₀ is the instantaneous internal transition frequency of the qubits from a ground state to an excited state.) Although it is possible to apply the same vector of amplitudes to all the qubits, embodiments of the present invention relate to the more general case in which a different, respective amplitude vector rₙ is applied to each qubit independently, so that the complete set of amplitudes can be represented by a matrix r of dimensions N×M. (Cases in which all ions are driven by the same global beam or by beams that overlap several ions are special cases of the independent drive described here.)

A set of N(N−1)/2 coupling matrices A_{n,m}, having dimensions M×M, is defined to represent the interactions between the excitation frequency pairs and the qubits n and m in the array, based on the normal modes of vibration of the qubits. Specifically,

$${A}_{n , m} = {\sum }_{j = 1}^{N} {O}_{j}^{n} {O}_{j}^{m} {A}_{j} ,$$

with O an N×N matrix such that

$${O}_{j}^{n}$$

is the participation or the nth ion in the jth motional mode. Aⱼ represents the interactions between the excitation frequency pairs and the jth mode of motion. The A_{n,m} matrices are constructed as linear combinations of the Aⱼ matrices.

The target entanglement phase vector φ=<Ω_{1,2}, φ_{1,3}, . . . , φ_{1,N}, φ_{2,3}, . . . , φ_{N-1,N}> is achieved by applying amplitude vectors r₁, . . . , r_{N} that satisfy

$${r}_{N}^{T} {A}_{n , m} {r}_{m} = {φ}_{n , m}$$

for all 1<n<m<N. Finding the vectors, however, is a hard problem, as explained above.

A useful representation of the problem is constructed by considering the vector,

$${R}^{T} = ( {r}_{1}^{T} , {r}_{2}^{T} , … , {r}_{N}^{T} ) ,$$

i.e., a vector made of all the vectors of amplitude driving the various ions. We also define Ã_{n,m} as a NM×NM matrix made of N×N blocks of size M×M, which are all zero except for the (n, m) and (m, n) blocks, which take the value

$$\frac{1}{2} {A}_{n , m} .$$

with this formulation the optimization problem takes the form, R^{T} Ã_{n,m}R=φ_{n,m}, for all 1<n<m<N.

Therefore, in some embodiments, the solution process begins by finding an initial non-trivial amplitude vector R₀ satisfying the constraints

$${R}_{0}^{T} {A}_{n , m} {R}_{0} = 0$$

for an in 1<m<N, i.e., the entanglement phase Ω_{n,m}=0 for all qubit pairs.

As noted above, solving this zero-phase instance involves a number of quadratic constraints that is only on the order of N. The reduction from the order of N² quadratic constraint to N quadratic constraint is realized by solving the zero-phase instance

$${r}_{0}^{T} , {A}_{j} {r}_{0} = 0$$

for all the interaction matrices Aⱼ and all the N qubits and setting

$${R}_{0}^{T} = ( {r}_{0}^{T} , {r}_{0}^{T} , … , {r}_{0}^{T} ) ,$$

Once this initial solution has been found, parameters λ and D can be computed by a linear solution process to find a nearby amplitude vector R=λR₀+D that satisfies R^{T} A_{n,m}R=φ_{n,m} for all 1<n<m<N. (The vector R is “nearby” in the multidimensional solution space defined by the N·M vector elements of R in the sense that the magnitude of the vector D is small compared to that of λR₀.) The solution space is then optimized, for example in a gradient descent process, to find an optimized target vector Rₒₚₜ locally satisfying the constraint argmin |Rₒₚₜ| such that Rₒₚₜ^{T} Ã_{n,m}Rₒₚₜ=φ_{n,m} for all 1<n<m<N.

The solution Rₒₚₜ represents a set of spectral components in respective sidebands of the instantaneous internal transition frequency ω₀ and indicates the respective complex amplitudes (including magnitude and phase) of the spectral components that are to be applied to each of the qubits. Simultaneous application of these spectral components to the qubits in the array excites selected normal modes of vibration and causes the multi-qubit gate to switch from an initial state to a target state having the target entanglement phase vector φ. This operation implements the unitary evolution operator, U=exp[i Σ_{n<m} φ_{n,m}XₙXₘ], up to local qubit rotations, wherein Xₙ Xₘ is a correlated XX rotation on the n'th and m'th qubits.

The gate time of the multi-qubit gate is governed by the minimum spacing Δf between the respective vibrational frequencies of the group of normal modes that are excited by the applied radiation. In the adiabatic limit, with gate time T >>1/Δf, the coupling matrices Aⱼ become diagonal, and an amplitude vector R that will satisfy the constraints can be found easily; but in this case the long gate time makes the multi-qubit gate impractical for actual quantum computations. Therefore, in some embodiments of the present invention, the coupling matrices are chosen to support a faster gate time, for example T<50/Δf or even T<10/Δf. The coupling matrices in such cases are generally of full rank, but the methods described above can be applied to find an optimal amplitude vector R that will enable the desired fast gate time. Constraints on the maximum infidelity and resilience to errors and noise can also be added to the solution process, to ensure that the resulting amplitude vectors will drive multi-qubit gates with high fidelity and robustness.

The respective vibrational frequencies of the normal modes that are used in the multi-qubit gate extend over a certain frequency range, from a minimum normal-mode frequency to a maximum normal-mode frequency. To achieve fast switching (with T<50/Δf), the bandwidth of the radiation that is used in driving the gate is at least 10% of this frequency range and may cover the entire frequency range.

Although the solution presented above uses frequency-domain analysis and optimization, the principles of the present invention may alternatively be implemented in the time domain. In this case, for example, the waveforms used to excite the qubits in the array may be defined in terms of time bins, with an optimal amplitude computed for each bin. An initial waveform of this sort is computed to achieve a zero entanglement phase, followed by a process of optimization to arrive at the target phase while satisfying constraints on gate time, fidelity, and other parameters.

Multi-qubit gates that are driven in accordance with the present methods may be used for a variety of computational tasks. The principles of the present invention may be applied in creating multi-qubit gates for universal quantum computation and/or to implement a part of a computational task or circuit together with other gates (which may comprise, one, two, or more qubits). As noted above, the present scheme implements many bi-partite entangling phases in parallel within the multi-qubit gate. Many N-qubit operations can be implemented using this sort of bi-partite, parallel operation. In addition, some N-qubit operations that cannot be performed in a single step using the multi-qubit gates can be implemented as part of a computational circuit (for example, by performing individual rotations between adjacent gates in the circuit). Thus, multi-qubit gates in accordance with embodiments of the invention can be used in creating a universal quantum computing scheme, with reduced quantum circuit depth (requiring fewer circuit layers for a given global operation) relative to schemes that are known in the art. The smaller quantum circuit depth enables faster circuits with potentially better overall fidelity.

Multi-qubit gates in accordance with embodiments of the invention can be used for realizing a universal quantum computation gate set (since any unitary operation can be sufficiently approximated using a circuit comprising single and multi-qubit gates as described herein) with high efficiency (since fewer circuit layers are needed for a given global operation). The universal gate set can be used in algorithmic tasks that include, for example, fault-tolerant circuits, surface and toric codes, Ising spin models, prime number factorization, and database search.

Moreover, using multi-qubit gates in accordance with embodiments of the invention, fewer quantum gates are needed for implementing a given algorithmic task, and accordingly the resultant circuit is executed faster. Such implementations provide enhanced coherence versus circuit time and overall better fidelity.

In addition to the implementation of parallel gate operations using bi-partite multi-qubit gate operations, the present methods are also beneficial in creating gates that give rise to highly connected entangled states, i.e., states in which many ions have substantial entanglement phases φ_{n,m} with two or more other ions. The entanglement phases are “substantial” in the sense that they have respective magnitudes that are at least 50% of the magnitude of the largest entanglement phase. For example, at least 10%, or possibly more than 20%, of the ions may have substantial entanglement phases with two or more other ions, or possibly with three or more of the ions.

Additionally or alternatively, the present methods can be used in creating gates that give rise to multiple non-local entanglements in parallel, i.e., entanglements between qubits that are not immediate neighbors. Specifically, there are multiple pairs of non-neighboring qubits (n,m) for which n-m is significant (for example, m-n≥4) with substantial entanglement phases φ_{n,m}, as defined above.

In some embodiments, such gates are configured to implement quantum error correction schemes, such as surface codes. An example of such an implementation is described below. In alternative embodiments, the present methods can be applied in driving quantum simulations.

In the presented description, for the sake of clarity and concreteness, the transition frequency @ is assumed to be the instantaneous frequency of a suitable electronic transition in a trapped-ion system, which is excited using laser radiation. The principles of the present invention may alternatively be applied, mutatis mutandis, to quantum gates based on other trapped-ion transitions, such as transitions between spin states of a Zeeman-split manifold, or between states in hyperfine-split manifolds, as well as to other types of quantum gates, in which case microwave or radiofrequency excitation may be used, as well as Raman coupling.

Furthermore, although the embodiments described herein relate specifically to trapped-ion quantum computing systems, the principles of the present invention may alternatively be applied, mutatis mutandis, to arrays of qubits of other sorts, such as superconducting (SC) qubits or an array of trapped neutral atoms inside an optical cavity. In trapped-ion systems, the qubits exploit the internal electronic degrees of freedom of the trapped ions (such as the electronic spins), while interactions between qubits are mediated by bosons based on the harmonic phonon modes. SC qubits exploit transmons, for example, and their interactions are mediated by bosons based on photonic excitation of a waveguide resonator to which all the SC qubits are coupled. In an alternative embodiment of the present invention, multi-qubit gates in SC can similarly be driven using sets of frequency components that are chosen using the methods of optimization that are described herein.

### System Description

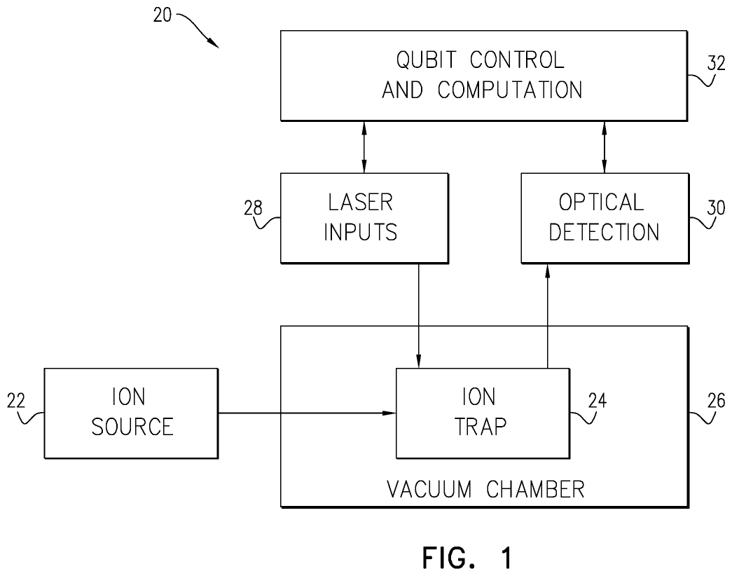

FIG. 1 is a block diagram that schematically illustrates a quantum computing system 20, in accordance with an embodiment of the invention. An atom source 22 injects a flow of neutral atoms, such as atoms of calcium, into a vacuum chamber 26 at ultra-high vacuum. A radiation source 28 directs several beams of radiation into vacuum chamber 26, including a beam that is tuned to ionize the atoms injected by source 22. (In the present example, as noted above, system 20 is assumed to be based on electronic transitions, and radiation source 28 is assumed to comprise lasers emitting beams of coherent radiation; but ionization, for example, may alternatively be carried out using an incoherent beam.) The resulting atomic ions are captured in an ion trap 24, such as a Paul trap, which uses RF fields to confine the ions along a specified line within the vacuum chamber 26. A magnetic field may also be applied to ion trap 24 to separate the different spin components of the electronic states of the ions into Zeeman levels.

An electronic qubit control and computation processor 32 drives radiation source 28 to direct additional beams toward the trapped ions in order to perform quantum computational operations and then read out the computational results. Typically, the results are read out by tuning a laser beam to an absorption line of one of the qubit states and then measuring the resulting fluorescent emission using an optical detector 30. Processor 32 receives the result of the computation and drives laser source 28 to perform additional computational steps in accordance with the algorithm being implemented.

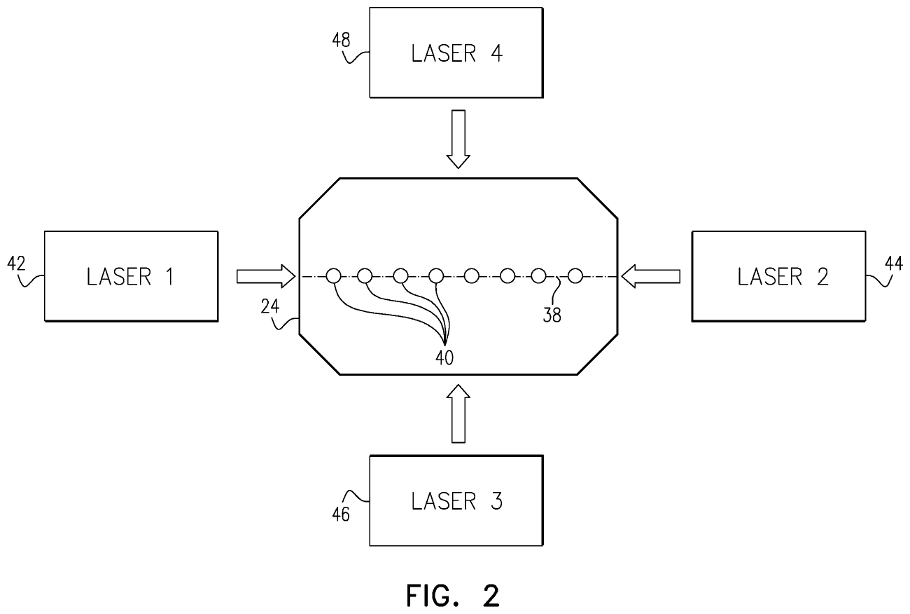

FIG. 2 is a block diagram that schematically illustrates an array of trapped ions 40 configured as qubits in a quantum computer, such as in system 20, in accordance with an embodiment of the invention. Laser source 28 (FIG. 1), provides several different laser beam inputs to ion trap 24 for different purposes. An ionization laser 42 ionizes the atoms output by atom source 22 to create ions 40, which are held in the trap. Additional cooling lasers 44 cool the ions to their electronic and motional ground states, by pumping appropriate state transitions of the ions while detuning the laser frequencies to engender mechanisms of Doppler cooling, sideband cooling, polarization gradient cooling, cooling by electrically-induced transparency (EIT), and/or other methods of cooling that are known in the art.

The cooled ions 40 are held in a linear array along an axis 38 by the electromagnetic fields within trap 24. Coulomb repulsion between ions 40 and trapping fields determine the equilibrium distance between the ions, as well as the phonon frequencies v of the normal vibrational modes of motion of ions 40 in the array, including both transverse and longitudinal modes of vibration. These normal vibrational modes give rise to vibrational sidebands of the optical transition frequencies between the states of ions 40. Absorption of a photon in one of these sideband frequencies causes an excitation or de-excitation of the vibrations of the array of ions due to the vibrational mode associated with the sideband, while driving the internal transition of the absorbing ion, thus transferring energy to the normal modes of the ion array and entangling the internal and motional states of the ions by a spin-dependent force. The mechanism of entanglement that it provides enables application of multi-qubit gates to these ions 40. Such gates may comprise five qubits or more, or even more than twelve qubits.

To operate the multi-qubit gate, an excitation laser 46 (or multiple lasers) coherently irradiates ions 40 with a set of excitation frequencies ω_{0±}ωₘ centered around a selected internal instantaneous transition ω₀ of the ions. The beam of laser 46 is modulated, for example by a suitable acousto-optic modulator, to coherently include frequency components in multiple sidebands ωₘ of the internal transition frequency ω₀, as defined above.

The amplitudes of the frequency components are chosen, using a protocol that is described further hereinbelow, so as to optimize the vector of amplitudes R of the frequency components that is applied to each of ions 40 in order to reach a target entanglement phase vector φ in a short gate time T. Laser 46 is operated to irradiate each of ions 40 with the selected frequency components at the optimal amplitudes for the gate time T to drive the multi-qubit gate from its initial state to an entangled target state. Although it is possible to apply the same set of sideband amplitudes to all the ions, in the present embodiments each ion 40 is driven with its own vector of amplitudes R, which typically differs from the amplitudes applied to the other ions. Examples of this sort of excitation spectra are presented below.

After completion of a computational cycle, a readout laser 48 reads the state of the qubit register defined by ions 40. Readout laser 48 is tuned to an absorption line of one of the states of the ions in the register. Absorption of the laser radiation by the ions in the appropriate state gives rise to fluorescence, which is measured by optical detector 30 (FIG. 1). Detector 32 measures the intensity of the fluorescent emissions and thus detects the final state of the gate.

Processor 32 typically comprises a general-purpose computer, with suitable interfaces to the other components of system 20. Processor 32 is driven by software to carry out the functions and computations that are described herein. The software may be stored on tangible, non-transitory computer-readable media, such as optical, magnetic, or electronic storage media.

### Selection and Optimization of Excitation Spectra

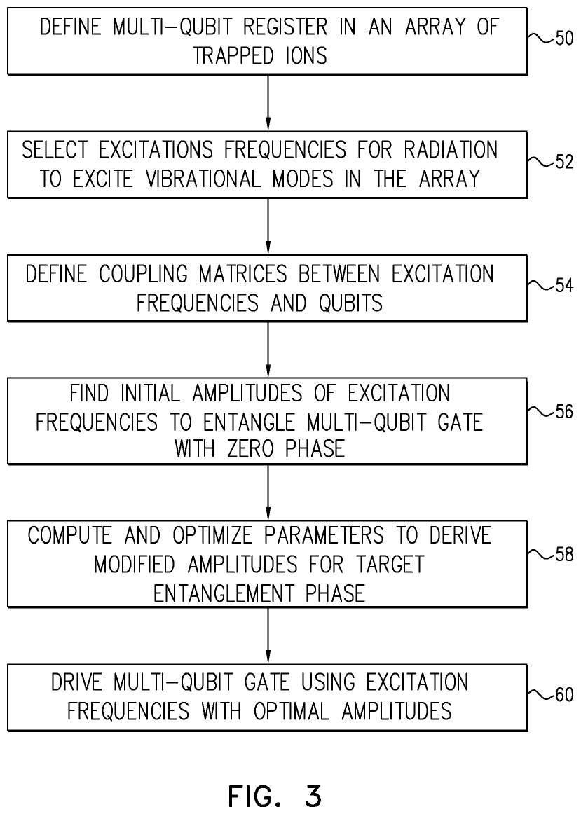

FIG. 3 is a flow chart that schematically illustrates a method for selecting parameters to drive a multi-qubit gate, in accordance with an embodiment of the invention. The method is typically carried out by a suitable computer, such as processor 32, under the control of appropriate software code.

The method of FIG. 3 begins with the definition of a multi-qubit register in an array of trapped ions, at a register definition step 50. The register is defined by the type and number N of ions 40 in trap 24 that are to participate in the gate, as well as parameters such as the internal instantaneous transition frequency ω₀ and the trap properties (which determine the normal mode frequencies vⱼ). A corresponding gate definition will also specify the target entanglement phase vector φ and the gate time T. As noted above, substantially any entanglement phase vector may be selected, depending on the desired functionality of the gate. To enable computations to be completed rapidly, the gate time T should be set to a small value, for example T<50/Δf or even T<10/Δf, wherein Δf is the minimal spacing between the respective vibrational frequencies vⱼ of the normal modes used in the gate.

The set of excitation frequencies that is to be used in driving the multi-qubit gate is defined at a frequency selection step 52. The frequency spectrum contains 2M components:

$${\{ {ω}_{0} \pm {ω}_{m} \}}_{m = 1}^{M} ,$$

when are applied with different amplitudes to each of the N ions. The field driving the nth ion is thus given by the following equation, in which the amplitude vector rₙ is broken into sine and cosine components

$${r}_{n}^{( s )} and {r}_{n}^{( c )} :$$

$${ω}_{n} ( t ) = 2 cos ( {ω}_{0} t + {φ}_{0} ) {\sum }_{m = 1}^{M} [ {( {r}_{n}^{( c )} )}_{m} cos ( {ω}_{m} t ) + {( {r}_{n}^{( s )} )}_{m} sin ( {ω}_{m} t ) ]$$

For efficient driving of the gate, it is beneficial to choose the tones ωₘ in the vicinity of the band of vibrational mode frequencies

$${\{ {v}_{j} \}}_{j = 1}^{N} ,$$

since the coupling between tones and modes scales inversely with the frequency difference between them. The field amplitude should vanish before t=0 and after t=T. Therefore, a convenient choice of tones is the harmonic basis

$${ω}_{m} = \frac{2 π}{T} {h}_{m} ,$$

wherein hₘ is the tone number.

As the first step in finding the amplitude vectors rₙ for driving each of the N ions, the coupling matrices between the excitation frequencies and the qubits are defined, at a coupling definition step 54. The coupling matrix between the motion of any pair of ions m and n is defined by the equation:

$${A}_{n , m} = - {\sum }_{j = 1}^{N} {η}_{j}^{2} {O}_{j}^{( n )} {O}_{j}^{( m )} ( \begin{matrix}{A}_{j}^{cos , cos} & {A}_{j}^{cos , sin} \\ {A}_{j}^{sin , cos} & {A}_{j}^{sin , sin}\end{matrix} )$$

In this equation, ηⱼ is the Lamb-Dicke parameter associated with the jth mode of motion, while

$${O}_{j}^{( n )} and {O}_{j}^{( m )}$$

are the normalized participation of the corresponding ions in the jth mode of motion. The elements of the matrix at the right side of the equation are defined as follows (with the operators f and g representing the sine and cosine as appropriate):

$${( {A}_{j}^{f , g} )}_{m , l} = - {\int }_{0}^{t} d {t}_{1} {\int }_{0}^{{t}_{1}} d {t}_{2} sin ( {ν}_{j} [ {t}_{1} - {t}_{2} ] ) [ f ( {ω}_{m} {t}_{1} ) g ( {ω}_{l} {t}_{2} ) + f ( {ω}_{m} {t}_{2} ) g ( {ω}_{l} {t}_{1} ) ]$$

The entanglement phase between ion n and ion m depends on the corresponding coupling matrix:

$${φ}_{n , m} = {r}_{n}^{T} {A}_{n , m} {r}_{m}$$

As explained above, the object of the present method is to choose the elements of the amplitude vectors rₙ for the chosen set of tones ωₘ that will yield the desired entanglement phase within the gate time T and minimize the norm of the rₙ's.

Rather than attempting to directly solve the full set of constraints inherent in the above equation, the target entanglement phase is initially set to zero: φ_{n,n}=0. A set of non-trivial amplitude vectors r for all the N ions is then derived to solve the problem

$${r}_{0}^{T} {A}_{j} {r}_{0} = 0 ,$$

with |r₀|=1 for all j=1, . . . , N, at a zero-phase solution step 56. As explained earlier, the choice of zero phase makes the solution independent of the different entanglement phases and thus reduces the number of constraints to the order of the number of ions N. Processor 32 typically finds the solution using numerical methods that are known in the art for solving systems of simultaneous equations.

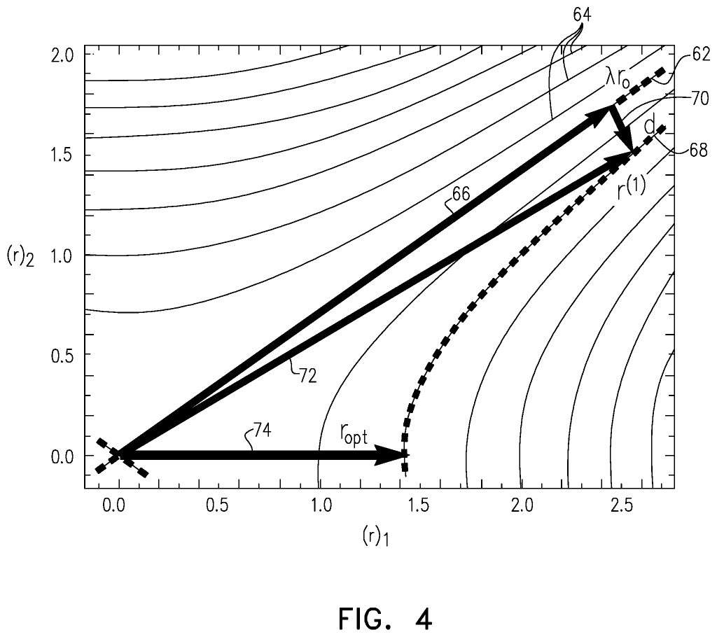

The zero-phase solution that is found at step 56 is used as the starting point for finding a modified set of amplitudes that will yield the desired set of target phases φₙ, at a parameter optimization step 58. This process of computation and optimization is based on the observation that if R₀ solves the zero-phase problem defined above, then any linear multiple of the solution, λR₀, will also solve the problem. Furthermore, when λ is large enough (corresponding to high intensity of the excitation beams), it is possible to achieve substantially any set of entanglement phases φ_{n,m} by applying an appropriate set of small deviations D to the intensities of the beams, i.e., to find a value of D such that R=λR₀+D satisfies R^{T} Ã_{n,m}R=φ_{n,m} for all 1<n<m<N. This principle is illustrated graphically in FIG. 4, as described below.

Specifically, assuming the magnitude of λR₀ to be much greater than that of D, the above expression for φ_{n,m} can be reduced approximately to a set of linear equations in D:

$${φ}_{n , m} = 2 λ {R}_{0}^{T} {\tilde{A}}_{n , m} D + 𝒪 ( ϵ )$$

The error term ∈ corresponds to the upper limit on infidelity of the multi-qubit gate.

Once D has been found satisfying the above equation, R=λR₌₀+D will define a set of beam amplitudes that will give rise to the target entanglement phase within the desired gate time T. This solution is non-optimal, however, since it requires irradiation of the ions with high laser amplitude. The solution is improved in a series of optimization steps to reduce both the residual error in the target phase φ_{n,m} and the magnitude of R. Any suitable optimization technique that is known in the art may be used for this purpose. For example in a linear gradient descent process, at each step s of the process, a correction D⁽ⁿ⁺¹⁾ is computed, to be applied to the current value R⁽ⁿ⁾ of the magnitude vector (starting from the value R=λR₀+D defined above). The desired correction in each step can be expressed by a set of linear equations:

$$( \begin{matrix}{Δφ}^{( s )} \\ - δ \vert {R}^{( s )} \vert\end{matrix} ) = ( \begin{matrix}{M}^{( s )} \\ {R}^{( s )}\end{matrix} ) {D}^{( s + 1 )}$$

In this equation, Δφ⁽ⁿ⁾ is the constraint error, given by

$${Δφ}_{n , m}^{( s + 1 )} = {φ}_{n , m} - {( {R}^{( s )} )}^{T} {\tilde{A}}_{n , m} {R}^{( s )} ,$$

δ represents the reduction in R, and the elements of the correction matrix M⁽ⁿ⁾ are given by

$${M}_{( n , m ) , k}^{( s )} = 2 {( {( {R}^{( s )} )}^{T} {\tilde{A}}_{n , m} )}_{k} .$$

This process continues until an optimized solution Rₒₚₜ is found, locally satisfying the condition argmin |Rₒₚₜ| such that Rₒₚₜ^{T} Ã_{n,m}Rₒₚₜ=φ_{n,m}, to within the specified fidelity limit. This solution is one of many possible solutions to the initial set of constraints. Therefore, in some embodiments, steps 56 and 58 are repeated multiple times, to find multiple zero-phase solutions and then optimize each of them. The solution giving the best performance, in terms of parameters including gate time, fidelity, robustness, and drive intensity, can then be selected.

Once an optimal solution has been found, the N ions in the multi-qubit gate are driven at the spectrum of M frequencies

$${\{ {ω}_{0} \pm {ω}_{m} \}}_{m = 1}^{M} ,$$

with the respective amplitudes defined by Rₒₚₜ for each ion, at a gate driving step 60. Thus, processor 32 is able to perform quantum computations using the N-qubit gate.

FIG. 4 is a plot that schematically illustrates the selection of amplitudes of spectral components used in driving a multi-qubit gate according to the method described above, in accordance with an embodiment of the invention. In this simplified example, an ion is driven by two tones, with respective amplitudes r₁ and r₂. The coupling matrix is A₁=diag(1,−2), and the entanglement phase is φ₁=2.

In FIG. 4, zero-phase solutions lie along an axis 62, while contours 64 represent solutions for larger and smaller values of ω₁ (in integer increments). An arrow 66 represents the multiplied zero-phase solution λr₀. An arrow 70 represents the correction d, which generates the initial solution λr₀+d, represented by an arrow 72, to satisfy r^{T} Aₙr=2. This solution lies on a contour 68. The values of r are incrementally optimized along contour 68 until an optimal solution rₒₚₜ is found, represented by an arrow 74.

### Implementation Example—Surface Codes

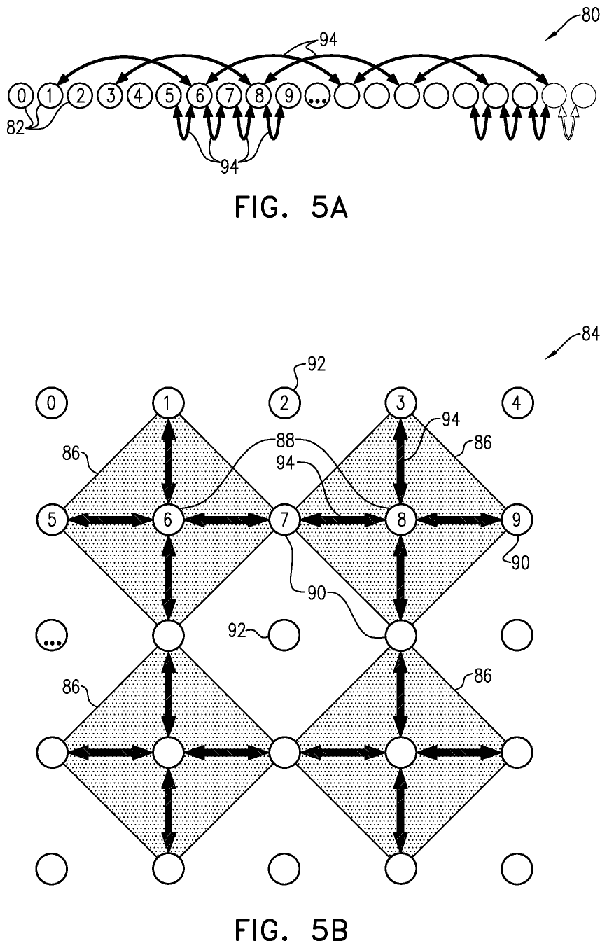

FIGS. 5A and 5B are diagrams showing a physical arrangement 80 and a logical arrangement 84, respectively, of an array of trapped ions 82 implementing an entanglement gate required for the surface code, for use in quantum error correction, in accordance with an embodiment of the invention. This code is shown here as an example of a multi-qubit operation that can be implemented practically using the techniques that are described above.

Logical arrangement 84 of the surface code is made up of four “plaquettes” 86, which can be used to evaluate the ox parity of ancilla qubits 88 in order to detect and correct errors in a quantum computation. Each plaquette 86 is composed of five ions, including the central ancilla qubit 88 and four edge qubits 90, which are coupled by pairwise links 94 to the ancilla qubit. Links 94 are created by setting appropriate coupling phases between ancilla qubits 88 and the corresponding edge qubits 90 in the trapped ion array, and then selecting the excitation frequency spectra, using the methods described herein, to implement these coupling phases. Ions 92 that do not participate in the surface code do not participate in the entanglement operation and are not connected by links 94.

In the present example, physical arrangement 80 comprises an equally-spaced chain of ⁴⁰Ca⁺ ions with an inter-ion distance of 5 μm. (Alternatively, the techniques presented here can be applied to other sorts of ion chains, including non-equally spaced arrangements). The qubits are mapped to the ground-state Zeeman 5S_{1/2} manifold and are driven with a laser field at 400 nm using a Raman transition, which couples the ions using transverse vibrational modes at frequencies in the range 1-2 MHz. Coupling matrices A_{m,n} are constructed corresponding to the entanglement required by links 94, and a respective amplitude vector rₙ is computed and optimized for each of ions 82 using the techniques described above. The gate time is set, for example, to the value T=2.5Tₘᵢₙ, wherein Tₘᵢₙ is the inverse of the minimal angular frequency difference Δf between the vibrational frequencies of the normal modes used in implementing the gate.

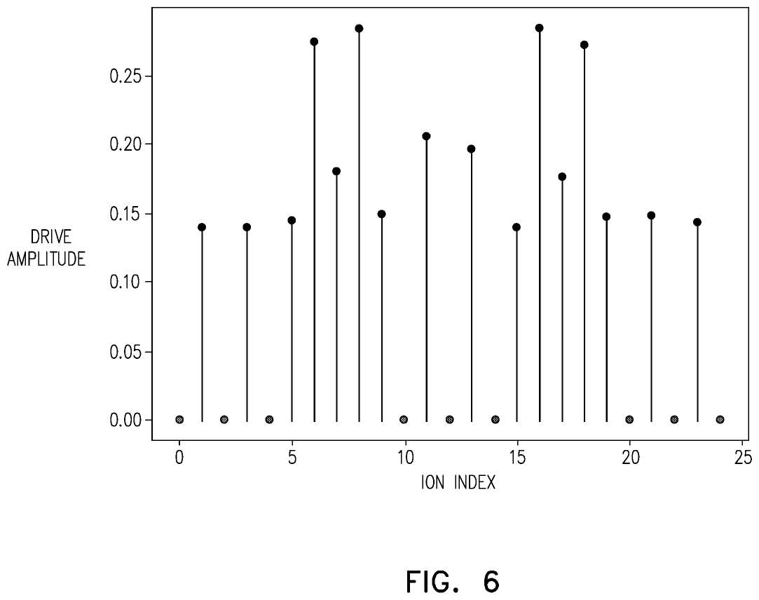

FIG. 6 is a plot that schematically illustrates the drive amplitudes applied to ions 82 in physical array 80, in accordance with an embodiment of the invention. The vertical bars in this figure show the total magnitude |rⱼ| of the laser frequencies that are applied to each of the ions in accordance with an optimal solution that was found using the method of FIG. 3. Ancilla qubits 88 (ions #6, 8, 16, and 18) are driven most strongly, as they each have four links 94, while edge qubits are driven at lower amplitude. Uncoupled ions 92 are not driven at all.

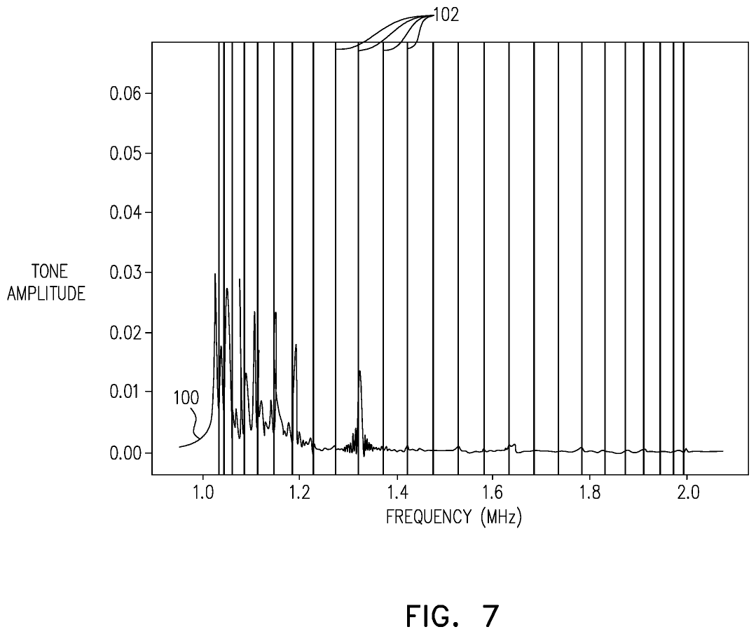

FIG. 7 is a plot that schematically illustrates the amplitudes of the spectral components that are used to drive ions 82 in array 80 using optimal amplitude vectors, in accordance with an embodiment of the invention. A curve 100 shows the average amplitudes of the driving tones as a function of frequency, overlaid on vertical bars 102 marking the normal vibrational modes of array 80. The spectrum of curve 100 is concentrated at frequencies near the vibrational mode frequencies, and is dominated by the frequencies at the low end of the spectrum, which are more effective in differentiating between the entanglements of adjacent ions.

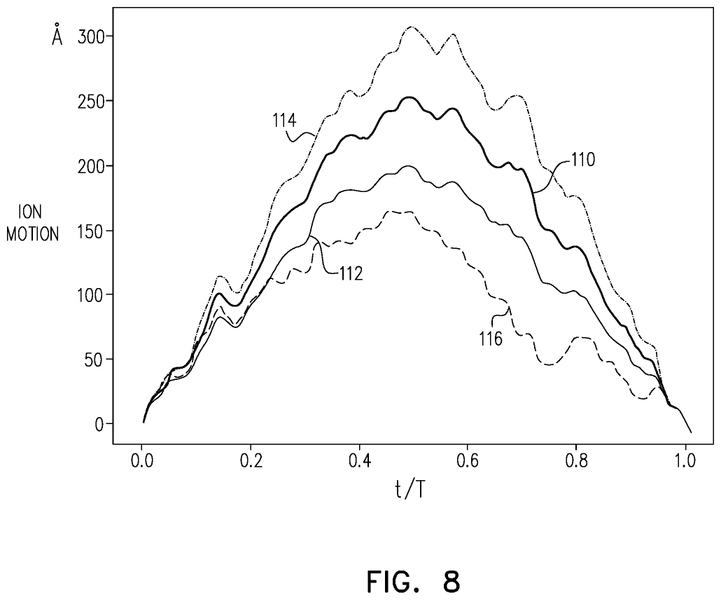

FIG. 8 is a plot that schematically illustrates the amplitude of vibrational motion over time of ions 82 in array 80, in accordance with an embodiment of the invention. The motion begins at time t=0, when the laser radiation is applied in accordance with the optimal amplitude vectors, and ends at the gate time t=T.

A curve 110 represents the average motion over time of the coupled ions (including edge qubits 90), while a curve 112 represents the average motion over time of uncoupled ions 92. An upper curve 114 represents the motion of ion #6 (one of ancilla qubits 88), while a lower curve 116 represents the uncoupled ion #12 at the center of array 82. The curves show that although uncoupled ions 92 are not driven by the laser beams, they nonetheless participate in the vibrational modes of array 80. The ability to apply different, optimized amplitude vectors rⱼ to the different ions, however, minimizes the energy that is wasted on these uncoupled ions and enables the present 25-qubit gate to achieve high fidelity within a fast gate time.

Although the examples presented above relate, for the sake of concreteness and clarity, to linear arrays of qubits (and specifically to linear arrays of trapped ions), the principles of the present invention may be applied, mutatis mutandis, to other sorts of qubit arrays, including two-dimensional and three-dimensional arrays. Furthermore, the present methods for quantum computing may be applied in implementing multi-qubit gates within segments of a segmented qubit arrays, for example as described in PCT Patent Application PCT/IB2024/052100, filed Mar. 5, 2024, whose disclosure is incorporated herein by reference. These methods may also be integrated with other multi-trap techniques that are known in the art for scale-up of quantum computations, such as photonic interconnects among ion chains; quantum charge-coupled device architectures (including various ion shuttling schemes); and two-dimensional arrays of traps that use dipole-dipole interactions for entanglement. All such alternative configurations and implementations are considered to be within the scope of the present invention.

The embodiments described above are cited by way of example, and the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A system for quantum computing, comprising:
an array of qubits having an internal transition frequency from a ground state to an excited state and having multiple normal modes of vibrational motion among the qubits in the array, the normal modes having respective vibrational frequencies;
a radiation source, configured to apply simultaneously to multiple qubits in the array radiation comprising a set of spectral components in multiple vibrational sidebands of the internal transition frequency such that the spectral components are applied to each of the qubits with different, respective complex amplitudes, wherein the sidebands are generated by a group of the normal modes having a minimal spacing Δf between the respective vibrational frequencies of the normal modes in the group; and
a controller configured to initialize a multi-qubit gate, comprising at least five of the qubits in the array, to an initial state and to drive the radiation source to apply the radiation to each of the qubits with respective complex amplitudes of the spectral components in the set selected so as to switch the multi-qubit gate to a target state within a gate time that is less than 50/Δf.

2. The system according to claim 1, wherein the respective vibrational frequencies of the normal modes in the group extend over a frequency range from a minimum normal-mode frequency to a maximum normal-mode frequency, and wherein the controller is configured to drive the radiation source to apply the radiation with a bandwidth that is at least 10% of the frequency range.

3. The system according to claim 1, and comprising an ion trap, wherein the array of qubits comprises an array of ions held in the trap, and wherein the multi-qubit gate comprises at least five of the ions in the array.

4. The system according to claim 3, wherein the internal transition frequency is an electronic transition frequency, and wherein applying the radiation comprises applying laser radiation.

5. The system according to claim 3, wherein the internal transition frequency is a Raman transition frequency.

6. The system according to claim 3, wherein applying the radiation comprises applying radio-frequency (RF) radiation.

7. The system according to claim 3, wherein the array of the ions is a linear array.

8. The system according to any of claims 1-7, wherein the multi-qubit gate comprises more than twelve of the qubits in the array.

9. The system according to any of claims 1-7, wherein the gate time is less than 10/Δf.

10. The system according to any of claims 1-7, wherein the multi-qubit gate is configured to implement a quantum error correction code.

11. The system according to claim 10, wherein the quantum error correction code comprises a surface code.

12. The system according to any of claims 1-7, wherein the target state of the multi-qubit gate is characterized by a target entanglement phase vector φ, and wherein the respective complex amplitudes of the spectral components are chosen by finding an initial set of the complex amplitudes that will yield zero entanglement phase, followed by optimization of the complex amplitudes to produce the target entanglement phase vector.

13. The system according to any of claims 1-7, wherein the target state is a highly connected entangled state.

14. The system according to any of claims 1-7, wherein the target state comprises multiple non-local entanglements.

15. A method for quantum computing, comprising:
providing an array of qubits having an internal transition frequency from a ground state to an excited state and having multiple normal modes of vibrational motion among the qubits in the array, the normal modes having respective vibrational frequencies;
initializing a multi-qubit gate, comprising at least five of the qubits in the array, to an initial state;
applying radiation simultaneously to multiple qubits in the array, the radiation comprising a set of spectral components in multiple vibrational sidebands of the internal transition frequency such that the spectral components are applied to each of the qubits with different, respective complex amplitudes, wherein the sidebands are generated by a group of the normal modes having a minimal spacing Δf between the respective vibrational frequencies of the normal modes in the group; and
selecting the respective complex amplitudes of the spectral components in the set so as to switch the multi-qubit gate to a target state within a gate time that is less than 50/Δf.

16. The method according to claim 15, wherein the respective vibrational frequencies of the normal modes in the group extend over a frequency range from a minimum normal-mode frequency to a maximum normal-mode frequency, and wherein the radiation is applied with a bandwidth that is at least 10% of the frequency range.

17. The method according to claim 15, wherein providing the array comprises trapping ions in an ion trap, and wherein the multi-qubit gate comprises at least five of the ions in the array.

18. The method according to claim 17, wherein the internal transition frequency is an electronic transition frequency, and wherein applying the radiation comprises applying laser radiation.

19. The method according to claim 17, wherein the internal transition frequency is a Raman transition frequency.

20. The method according to claim 17, wherein applying the radiation comprises applying radio-frequency (RF) radiation.

21. The method according to claim 17, wherein the array of the ions is a linear array.

22. The method according to any of claims 15-21, wherein the multi-qubit gate comprises more than twelve of the qubits in the array.

23. The method according to any of claims 15-21, wherein the gate time is less than 10/Δf.

24. The method according to any of claims 15-21, wherein the multi-qubit gate implements a quantum error correction code.

25. The method according to claim 24, wherein the quantum error correction code comprises a surface code.

26. The method according to any of claims 15-21, wherein the target state of the multi-qubit gate is characterized by a target entanglement phase vector q, and wherein selecting the respective complex amplitudes comprises finding an initial set of the complex amplitudes that will yield zero entanglement phase, followed by optimization of the complex amplitudes to produce the target entanglement phase vector.

27. The method according to any of claims 15-21, wherein the multi-qubit gate gives rise to a highly connected entangled state.

28. The method according to any of claims 15-21, wherein the multi-qubit gate gives rise to multiple non-local entanglements.

29. A method for quantum computing, comprising:
providing an array of qubits having an internal instantaneous transition frequency ω₀ from a ground state to an excited state;
initializing a multi-qubit gate, comprising a first number N>2 of the qubits in the array, to an initial state;
selecting a second number M>2 of excitation frequency pairs having respective frequencies ω_{0±}ωₘ and respective amplitudes rₘ defined by an amplitude vector R=<r₁, r₂, . . . , r_{M}>;
defining a set of N(N−1)/2 coupling matrices A_{n,m} with 1<n<m<N having dimensions M×M representing interactions between the excitation frequency pairs and qubits pairs;
finding an initial amplitude vector r₀ satisfying the constraint |r₀|=1 such that
$${r}_{0}^{T} {A}_{j} {r}_{0} = 0$$
for all j=1, . . . , N;
selecting a target entanglement phase vector φ=<φ_{1,2}, ω_{1,3}, . . . φ_{1,N}, φ_{2,1} . . . , φ_{N-1,N}>;
computing parameters λ and D to find a target amplitude vector R=λR₀+D that satisfies R^{T} Ã_{n,n}R=φ_{n,n} for all 1<n<m<N, with
$${R}^{T} = ( {r}_{1}^{T} , {r}_{2}^{T} , … , {r}_{N}^{T} ) ,$$
wherein
$${R}_{0} = ( {r}_{0}^{T} , {r}_{0}^{T} , … , {r}_{0}^{T} )$$
driving the multi-qubit gate to a target state by applying radiation to the array of qubits, the radiation comprising the M excitation frequency pairs with amplitudes in accordance with the target amplitude vector R.

30. The method according to claim 29, and comprising, after finding the target amplitude vector R, applying a process of optimization to find an optimized target vector Rₒₚₜ locally satisfying the constraint argmin |Rₒₚₜ| such that Rₒₚₜ^{T} Ã_{n,m}Rₒₚₜ=φ_{n,m} for all 1<n<m<N.

31. The method according to claim 30, wherein applying the process of optimization comprises reducing a residual error in a target phase φ_{n,m}.

32. The method according to claim 30, wherein applying the process of optimization comprises iteratively modifying the target amplitude vector so as to reduce a magnitude of the target amplitude vector while reaching the target entanglement phase vector to within a predefined error.

33. The method according to claim 29, wherein the respective frequencies ω_{0±}ωₘ are chosen to excite sidebands of the transition frequency due to a group of normal modes of vibration of the qubits.

34. The method according to claim 33, wherein the respective vibrational frequencies of the normal modes in the group extend over a frequency range from a minimum normal-mode frequency to a maximum normal-mode frequency, and wherein the chosen frequencies extend over a bandwidth that is at least 10% of the frequency range.

35. The method according to claim 33, wherein the sidebands are generated by a group of the normal modes having a minimal spacing Δf between the respective vibrational frequencies of the normal modes in the group, and wherein the target amplitude vector is computed so that the multi-qubit gate switches to the target state within a gate time that is less than 50/Δf.

36. The method according to claim 29, wherein finding the target amplitude vector comprises computing, for each of the qubits, different, respective complex amplitudes of the excitation frequency pairs.

37. The method according to claim 29, and comprising defining a gate time T of the multi-qubit gate, wherein computing the target amplitude vector comprises selecting the target amplitude vector so as that the multi-qubit gate switches to the target state at the defined gate time.

38. The method according to claim 29, and comprising defining a target infidelity of the multi-qubit gate, wherein computing the target amplitude vector comprises selecting the target amplitude vector so as that the multi-qubit gate switches to the target state with an infidelity no greater than the target infidelity.

39. The method according to any of claims 29-38, wherein the qubits comprise trapped ions.

40. The method according to claim 39, wherein the internal transition frequency is an electronic transition frequency, and wherein applying the radiation comprises applying laser radiation.

41. The method according to any of claims 29-38, wherein the multi-qubit gate comprises at least five qubits.

42. The method according to claim 41, wherein the multi-qubit gate comprises more than twelve qubits.

43. The method according to any of claims 29-38, wherein the multi-qubit gate is configured to implement a quantum error correction code.

44. The method according to any of claims 29-38, wherein finding the initial amplitude vector comprises solving a set of quadratic constraints of an order N.

45. The method according to any of claims 29-38, wherein the multi-qubit gate gives rise to a highly connected entangled state.

46. The method according to any of claims 29-38, wherein the multi-qubit gate gives rise to multiple non-local entanglements.

47. A system for quantum computing, comprising:
an array of qubits having an internal instantaneous transition frequency ω₀ from a ground state to an excited state; and
a radiation source, configured to initialize a multi-qubit gate, comprising a first number N>2 of the qubits in the array, to an initial state, and to drive the multi-qubit gate to a target state by applying radiation to the array of qubits,
wherein the radiation comprises a second number M>2 of excitation frequency pairs having respective frequencies ω_{0±}ωₘ and respective amplitudes rₘ defined by a target amplitude vector R=<r₁, r₂, . . . , r_{M}>,
wherein the target amplitude vector R is computed by:
defining a set of N(N−1)/2 coupling matrices A_{n,m} with 1<n<m<N having dimensions M×M representing interactions between the excitation frequency pairs and qubits pairs;
finding an initial amplitude vector r₀ satisfying the constraint |r₀|=1 such that
$${r}_{0}^{T} {A}_{j} {r}_{0} = 0$$
for all j=1, . . . , N;
selecting a target entanglement phase vector φ=<φ_{1,2}, ω_{1,3}, . . . φ_{1,N}, φ_{2,1} . . . , φ_{N-1,N}>; and
computing parameters λ and D to find the target amplitude vector R=ΔR₀+D that satisfies R^{T} Ã_{n,n}R=φ_{n,n} for all 1<n<m<N, with
$${R}^{T} = ( {r}_{1}^{T} , {r}_{2}^{T} , … , {r}_{N}^{T} ) ,$$
wherein
$${R}_{0} = ( {r}_{0}^{T} , {r}_{0}^{T} , … , {r}_{0}^{T} ) .$$

48. The system according to claim 47, wherein the target amplitude vector R is computed by applying, after finding the target amplitude vector R, a process of optimization to find an optimized target vector Rₒₚₜ locally satisfying the constraint argmin |Rₒₚₜ| such that Rₒₚₜ^{T} Ã_{n,m} Rₒₚₜ=φ_{n,m} for all 1<n<m<N.

49. The system according to claim 48, wherein applying the process of optimization comprises reducing a residual error in a target phase φ_{n,m}.

50. The system according to claim 48, wherein applying the process of optimization comprises iteratively modifying the target amplitude vector so as to reduce a magnitude of the target amplitude vector while reaching the target entanglement phase vector to within a predefined error.

51. The system according to claim 47, wherein the respective frequencies ω_{0±}ωₘ are chosen to excite sidebands of the transition frequency due to a group of normal modes of vibration of the qubits.

52. The system according to claim 51, wherein the respective vibrational frequencies of the normal modes in the group extend over a frequency range from a minimum normal-mode frequency to a maximum normal-mode frequency, and wherein the chosen frequencies extend over a bandwidth that is at least 10% of the frequency range.

53. The system according to claim 51, wherein the sidebands are generated by a group of the normal modes having a minimal spacing Δf between the respective vibrational frequencies of the normal modes in the group, and wherein the target amplitude vector is computed so that the multi-qubit gate switches to the target state within a gate time that is less than 50/Δf.

54. The system according to claim 47, wherein finding the target amplitude vector comprises computing, for each of the qubits, different, respective complex amplitudes of the excitation frequency pairs.

55. The system according to claim 47, wherein the target amplitude vector is computed by defining a gate time T of the multi-qubit gate and selecting the target amplitude vector so as that the multi-qubit gate switches to the target state at the defined gate time.

56. The system according to claim 47, wherein the target amplitude vector is computed by defining a target infidelity of the multi-qubit gate and selecting the target amplitude vector so as that the multi-qubit gate switches to the target state with an infidelity no greater than the target infidelity.

57. The system according to any of claims 47-56, wherein the qubits comprise trapped ions.

58. The system according to claim 57, wherein the internal transition frequency is an electronic transition frequency, and wherein applying the radiation comprises applying laser radiation.

59. The system according to any of claims 47-56, wherein the multi-qubit gate comprises at least five qubits.

60. The system according to claim 59, wherein the multi-qubit gate comprises more than twelve qubits.

61. The system according to any of claims 47-56, wherein the multi-qubit gate is configured to implement a quantum error correction code.

62. The system according to any of claims 47-56, wherein finding the initial amplitude vector comprises solving a set of quadratic constraints of an order N.

63. The system according to any of claims 47-56, wherein the multi-qubit gate gives rise to a highly connected entangled state.

64. The system according to any of claims 47-56, wherein the multi-qubit gate gives rise to multiple non-local entanglements.
